(19) United States
(12) Patent Application Publication
(10) Pub. No.: US 2022/0371160 A1
(43) Pub. Date: Nov. 24, 2022

(54) VICE JAW QUICK DEMOUNTING STRUCTURE

(71) Applicant: Chun-Wei Chang, New Taipei City (TW)

(72) Inventor: Chun-Wei Chang, New Taipei City (TW)

(21) Appl. No.: 17/336,344

(22) Filed: Jun. 2, 2021

(30) Foreign Application Priority Data
May 19, 2021 (TW) 110205737

(51) Int. Cl. B25B 1/10; B25B 1/02

(52) U.S. Cl. CPC B25B 1/10; B25B 1/02

(57) ABSTRACT

A vice jaw quick demounting structure, comprising a vice main body, a lead screw positioning seat, a lead screw, and first and second jaw sets, characterized in that: the first and second jaw sets both have a slide, a jaw and a limiting component; the top wall of the slide is protruded to form a limiting block, one side of the slide is protruded to form a [symbol] -shaped stop block, and the left and right side walls are both configured with first and second embedding slots; the jaw has a slide chamber, and its front and rear side inner walls are respectively provided with a [symbol] -shaped containing groove, and the left and right side walls of the jaw are respectively configured with a through hole; the limiting component goes through the through hole and can slide between the first and second embedding slots.

### BACKGROUND OF INVENTION

### 1. Field of the Invention

The present invention relates generally to the technical field of vices, and more particularly to a vice jaw quick demounting structure enabling quick demounting of the jaw.

### 2. Description of Related Art

In the manufacturing of industrial parts, in order to cut or process the work piece, vices are commonly used to stably fix the work piece for processing. Due to dramatic vibration when processing the work pieces, the jaw must be firmly fixed on a base. Otherwise, the jaw may deflect upward and bring the work piece under processing to tilt upward. This may cause inaccurate processing or even pop-out of the work piece from the vice. Therefore, in a conventional vice, bolts are used to fix the jaw on the base, and locating pins is used to fasten the jaw on the base, so that the jaw and the base are tightly bound together to avoid shock on the base when the jaw clamps the work piece.

However, to demount the jaw from the base, the bolts and locating pins must firstly be taken out. This makes operation quite inconvenient. When multiple vices are used in an array, it is necessary to move away each vice to have sufficient space for the demounting of jaws. It takes a lot of labor and time.

In view of the above problem, it is the aim of the present invention to develop a vice jaw quick demounting structure that enables quick demounting of the vice jaw.

### SUMMARY OF THE INVENTION

The purpose of the present invention is to overcome the deficiencies of the prior art and to provide a vice jaw quick demounting structure.

In order to solve the above technical problems, the present invention adopts the following technical solutions:

A vice jaw quick demounting structure, comprising:

a vice main body, having a guide slot that extends vertically;

a lead screw positioning seat, configured in the center of the guide slot, having a lead screw positioning groove;

a lead screw, with its center configured with a positioning portion, the positioning portion is positioned at the lead screw positioning groove, and the two sides of the positioning portion are respectively configured with positive external spiral threads and reverse external spiral threads; and

a clamping and fixing module, including a first flexible jaw set and a second flexible jaw set configured inside the guide slot of the vice main body, capable of sliding, the first jaw set has positive internal spiral threads designed to match the positive external spiral threads of the lead screw, the second jaw set has reverse internal spiral threads designed to match the reverse external threads of the lead screw, so that the first jaw set and the second jaw set will generate simultaneous clamping or releasing actions when the lead screw is rotated;

wherein the first jaw set and second jaw set both include a slide that can slide inside the guide slot configured on the vice main body, a jaw to be fitted on the slide, and a limiting component respectively configured on the left side wall and right side wall of the jaw;

a top wall of the slide is configured with a limiting block protruding toward the jaw, one side of the limiting block is extended and protruded to form a [symbol] -shaped stop block, and the left side wall and the right side wall of the limiting block are both configured with a first embedding slot and a second embedding slot in upper and lower arrangement;

a bottom of the jaw is configured with a slide chamber that can be fitted on the limiting block, for the jaw to be fixed on the slide, the front side inner wall and rear side inner wall of the slide chamber respectively have a [symbol] shaped containing groove to match the [symbol] -shaped stop block, and the left side wall and right side wall of the jaw are respectively configured with a through hole that is communicated to the slide chamber;

the limiting component goes through the through hole and can slide between the first embedding slot and the second embedding slot, when the limiting component is fitted in the second embedding slot, the [symbol] -shaped stop block is held inside the [symbol] -shaped containing groove and pressed against the front side inner wall or rear side inner wall of the [symbol] -shaped containing groove, so that the jaw is fixed on the slide, when the limiting component is fitted in the first embedding slot, the [symbol] -shaped stop block is separated from the [symbol] -shaped containing groove, so that the jaw can be demounted from the slide.

More particularly, wherein the [symbol] -shaped stop block is made up of a first slope extending from one side of the limiting block, and a second slope configured in mirror symmetric relationship to the first slope, the [symbol] -shaped containing groove is made up of a first slope inner wall surface and a second slope inner wall surface matching the first slope and the second slope, when the jaw is fitted on the slide, the [symbol] -shaped stop block is held inside the [symbol] -shaped containing groove and the second slope is pressed against the second slope inner wall surface of the [symbol] -shaped containing groove, so that the jaw is fixed on the slide.

More particularly, wherein the limiting component is made up of a ball held inside the through hole, an elastic body pressed against the ball, and a screw locking component contacting the elastic body to press against the elastic body.

More particularly, wherein the jaw is an integrally formed L-shaped seat, having a clamping seat to be fitted on the slide, and a clamping block extending and protruding from one side of the clamping seat, a notch is formed between the clamping block and the clamping seat to hold the work piece.

More particularly, wherein the bottom of the jaw protrudes toward the guide slot to form two corresponding positioning convex blocks, the two positioning convex blocks respectively contact the wall of the vice main body on a vertical line, so that the jaw can deflect to the left or right, to tightly press on the clamped surfaces of the work piece, so that the work piece can be stably clamped.

More particularly, wherein the axle center (a1) of the [symbol] -shaped containing groove is lower than the axle center (a2) of the limiting component.

Based on the above-mentioned technical implementation, the present invention has the following advantages comparing to the prior art:

In the present invention, as the limiting component is configured inside the through holes on the left and right side walls of the jaw, the user can demount and replace the jaw simply by applying an upward force. Jaw replacement is very convenient. Also, through implementation of a protruding [symbol] -shaped stop block on the limiting block, the user can easily mount the jaw on the limiting block. Thus, the jaw can be mounted onto the limiting block or demounted from the limiting block without the need to remove the bolts and pins. The present invention makes operation very easy and convenient and can enhance efficiency and increase capacity of production.

Through the design of the present invention to enable the [symbol] -shaped stop block to push against the [symbol] -shaped containing groove, when the jaw clamps the work piece, the [symbol] -shaped stop block will push against the [symbol] -shaped containing groove, and the jaw will generate a downward pressing force, so as to avoid fluctuation or upward floating of the work piece clamped by the jaw.

### BRIEF DESCRIPTION OF THE DRAWINGS

FIG. 1 is a perspective view of the present invention;

FIG. 2 is an exploded view of the present invention;

FIG. 3 is a sectional view of the present invention;

FIG. 4-FIG. 6 are implementation view of the present invention with partial sections;

FIG. 7 is a left side view of the present invention;

FIG. 8 is a sectional view from I-I direction in FIG. 7;

FIG. 9 is a sectional view from II-II direction in FIG. 7;

FIG. 10 is an enlarged view of Part A in FIG. 9;

FIG. 11 is an implementation view of the present invention when the jaw is deflected;

FIG. 12 is a front side view of the present invention.

### DETAILED DESCRIPTION OF THE INVENTION

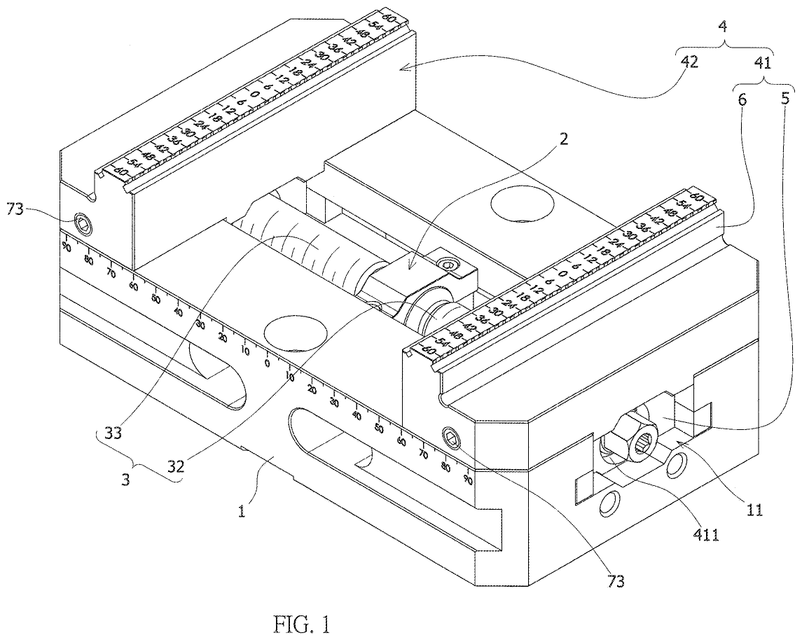

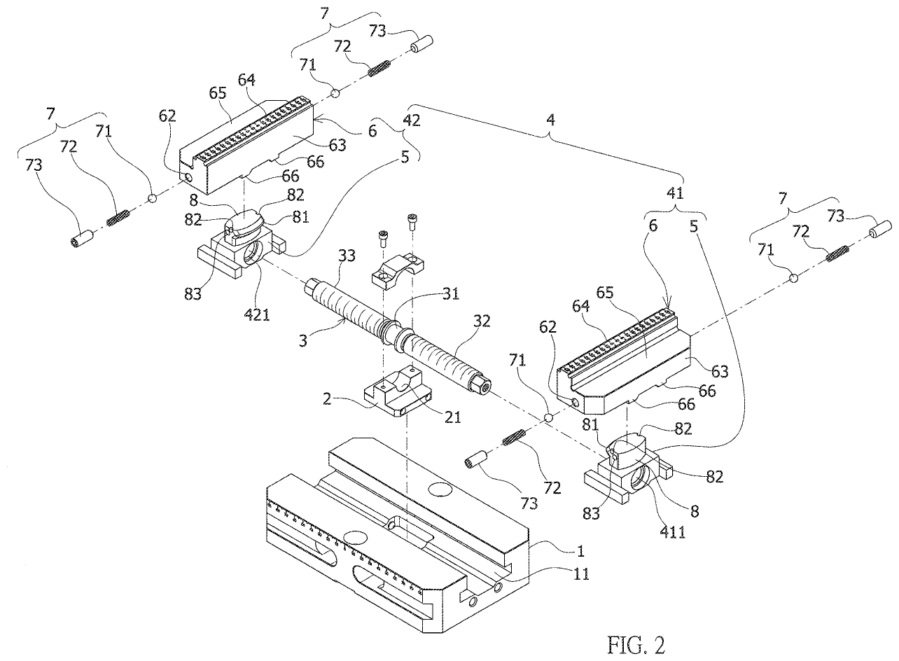

Below are detailed descriptions of the present invention with respect to the embodiments as disclosed in the figures/FIG. 1 and FIG. 2 disclose a vice jaw quick demounting structure, which comprises: a vice main body 1, a lead screw positioning seat 2, a lead screw 3 and a clamping and fixing module 4. Below are sequential descriptions of each component.

The vice main body 1 has a guide slot 11 extending vertically.

The lead screw positioning seat 2 is configured in the center of the guide slot 11 and has a lead screw positioning groove 21.

The lead screw 3 is centrally configured with a positioning portion 31 in a ring form, the positioning portion 31 is positioned at the lead screw positioning groove 21, and the two sides of the positioning portion 31 are respectively configured with positive external threads 32 and reverse external threads 33.

The clamping and fixing module 4 comprises a first jaw set 41 and a second jaw set 42 configured inside the guide slot 11 of the vice main body 1 and capable of sliding. The first jaw set 41 has positive internal spiral threads 411 corresponding to the positive external threads 32 of the lead screw 3, the second jaw set 42 has reverse internal spiral threads 421 corresponding to the reverse external threads 33 of the lead screw 3, so that the first jaw set 41 and the second jaw set 42 can generate simultaneous clamping or releasing actions along with the rotation of the lead screw 3.

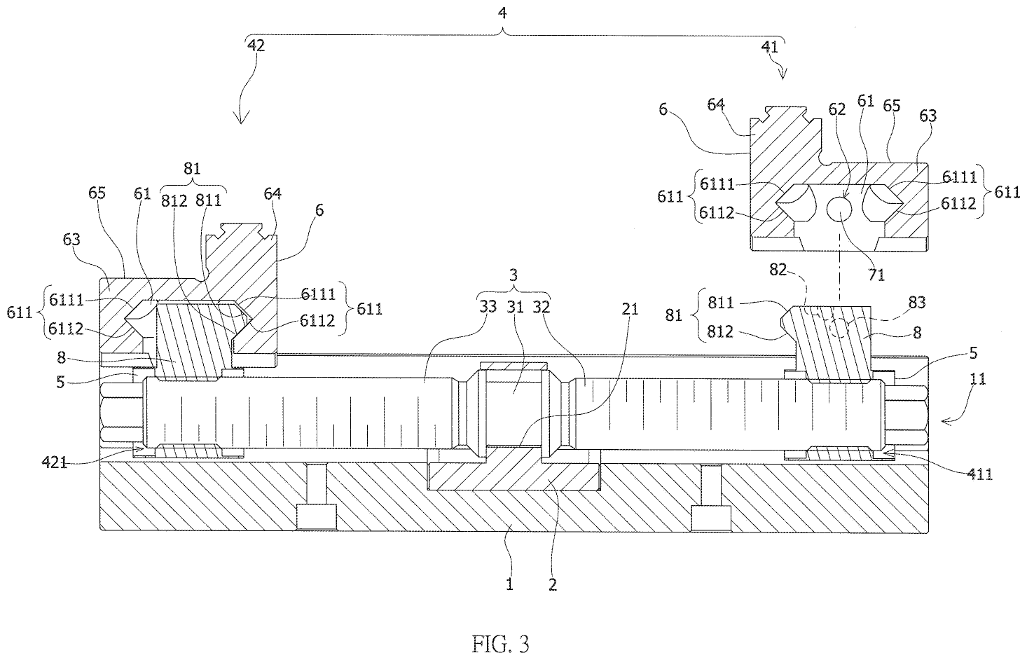

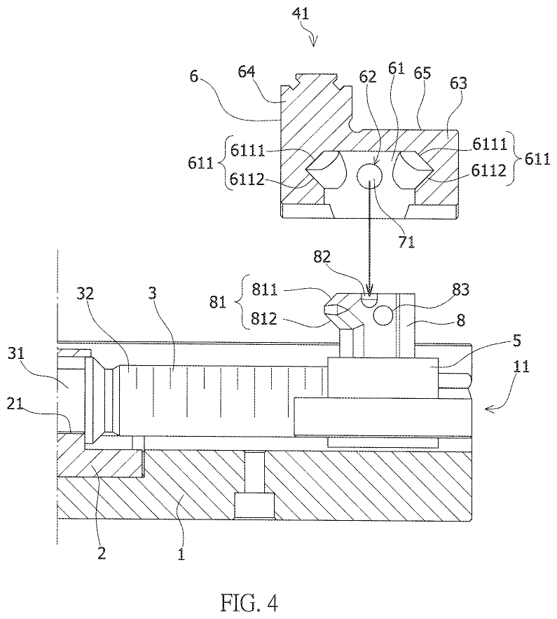

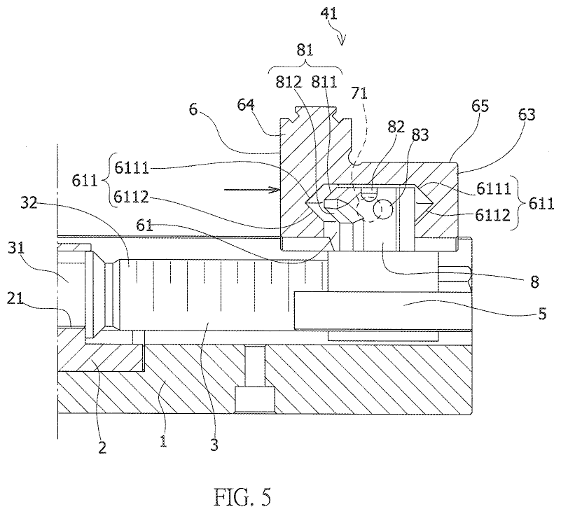

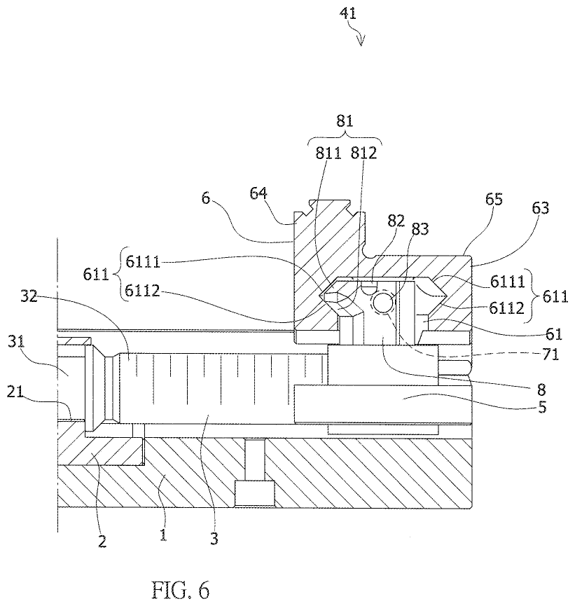

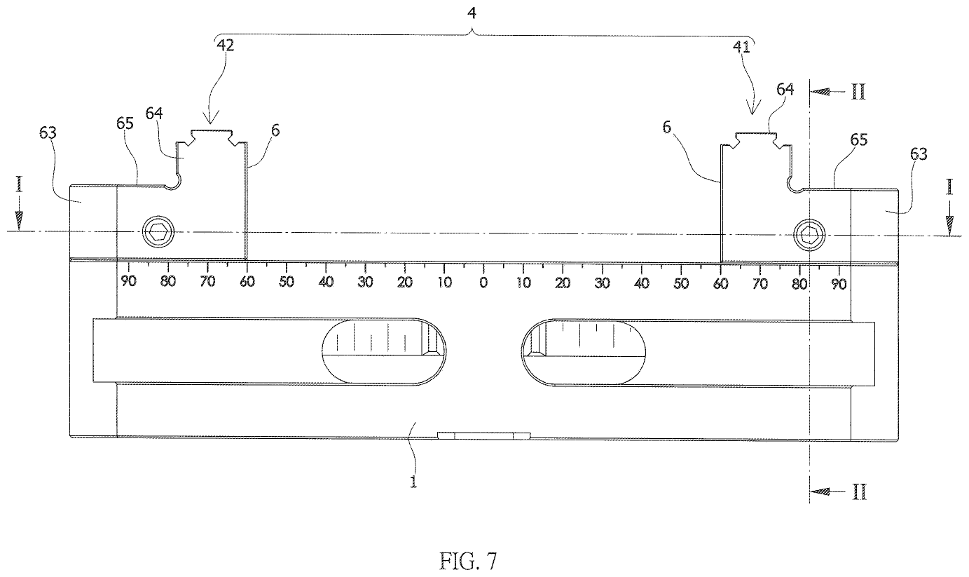

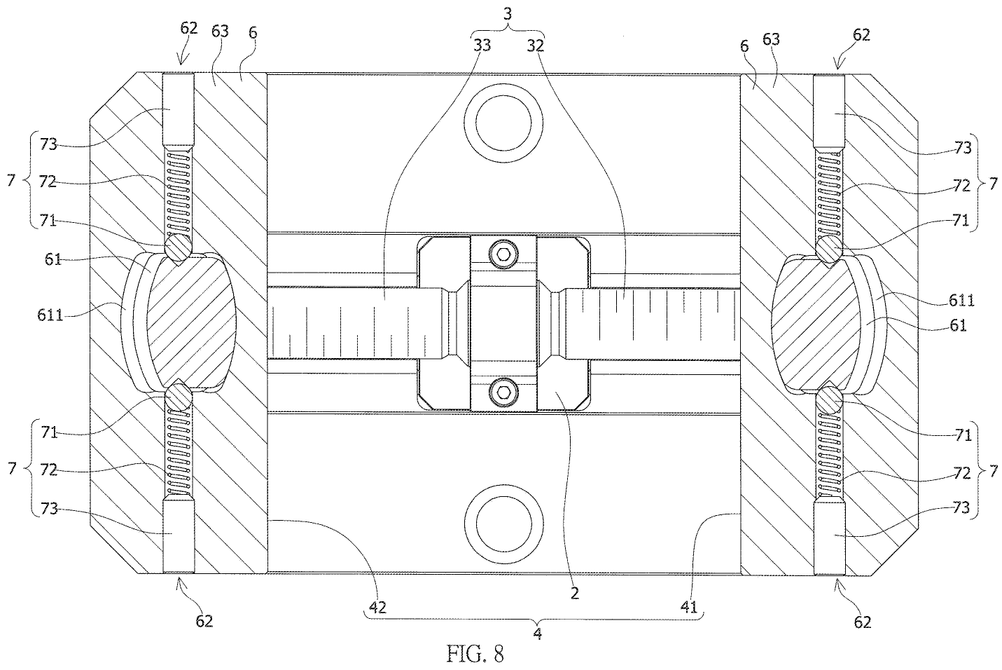

Referring to FIG. 3 through FIG. 8, both the first jaw set 41 and the second jaw set 42 include a slide 5 that can slide inside the guide slot 11 configured on the vice main body 1, a jaw 6 to be fitted on the slide 5, and a limiting component 7 respectively configured on the left side wall and right side wall of the jaw 6; the top wall of the slide 5 is configured with a limiting block 8 protruding toward the jaw 6. One side of the limiting block 8 is extended and protruded to form a [symbol] -shaped stop block 81. And the left side wall and right side wall of the limiting block 8 are both configured with a first embedding slot 82 and a second embedding slot 83 in upper and lower arrangement; the bottom of the jaw 6 is configured with a slide chamber 61 that can be fitted on the limiting block 8, so that the jaw 6 can be fixed on the slide 5. The front side inner wall and rear side inner wall of the slide chamber 61 respectively have a [symbol] -shaped containing groove 611 to match the [symbol] -shaped stop block 81, and the left side wall and right side wall of the jaw 6 are respectively configured with a through hole 62 that is communicated to the slide chamber 61; the limiting component 7 goes through the through hole 62 and can slide between the first embedding slot 82 and the second embedding slot 83.

When the limiting component 7 is fitted in the second embedding slot 83, the [symbol] -shaped stop block 81 is held inside the [symbol] -shaped containing groove 611 is pressed against the front side inner wall or rear side inner wall of the [symbol] -shaped containing groove 611, so that the jaw 6 is fixed on the slide 5. When the limiting component 7 is fitted in the first embedding slot 82, the [symbol] -shaped stop block 81 is separated from the [symbol] -shaped containing groove 611, and the user can simply apply an upward force to demount the jaw 6 from the slide 5. Thus, the jaw 6 can be quickly demounted for easy replacement.

Also, through implementation of a protruding [symbol] -shaped stop block 81 on the limiting block 8, the user can easily mount the jaw 6 on the limiting block 8. Thus, the jaw 6 can be mounted onto the limiting block 8 or demounted from the limiting block 8 without the need to remove the bolts and pins. The present invention makes operation very easy and convenient and can enhance efficiency and increase capacity of production.

As shown in FIG. 3 through FIG. 6, the [symbol] -shaped stop block 81 is made up of a first slope 811 extending and protruding from one side of the limiting block 8 and a second slope 812 configured in mirror symmetric relationship to the first slope 811, and the [symbol] -shaped containing groove 611 is made up of a first slope inner wall surface 6111 and a second slope inner wall surface 6112 configured to match the first slope 811 and the second slope 812. When the jaw 6 is fitted on the slide 5, the [symbol] -shaped stop block 81 is housed inside the [symbol] -shaped containing groove 611 and the second slope 812 is pushed against the second slope inner wall surface 6112 of the [symbol] -shaped containing groove 611, so that the jaw 6 is fixed on the slide 5.

Moreover, when the jaw 6 clamps the work piece [not shown in the figure], the [symbol] -shaped stop block 81 will push against the [symbol] -shaped containing groove 611, causing the second slope 812 to press the second slope inner wall surface 6112 downward to generate a downward pressure upon the jaw 6, so that fluctuation or upward floating can be avoided when the jaw 6 clamps the work piece [not shown in the figure].

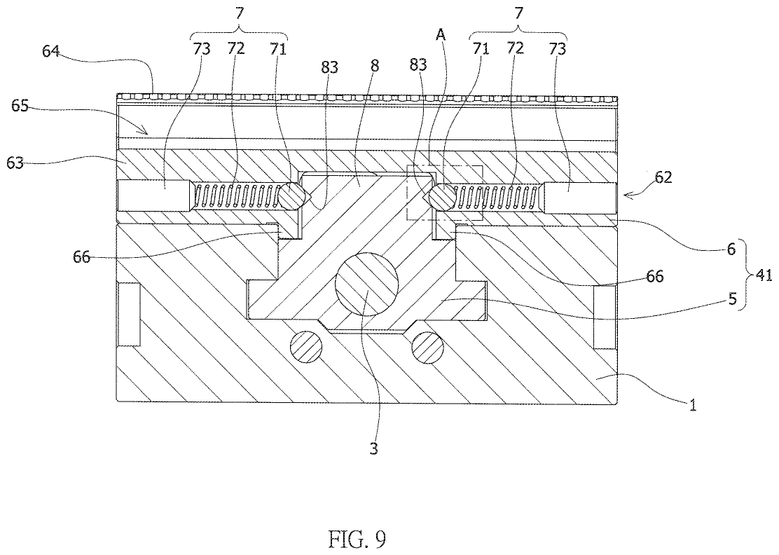

As shown in FIG. 9, the limiting component 7 is made up of a ball 71 held inside the through hole 62, an elastic body 72 pressed against the ball 71, and a screw locking component 73 contacting the elastic body 72 to press against the elastic body 72. The ball 71 is fitted on the external edge of the through hole 62 and protrudes out of the through hole 62.

Based on this structure, when the jaw 6 is mounted on the limiting block 8, the ball 71 slides from the left side wall and right side wall of the limiting block 8 toward the second embedding slot 83. When the [symbol] -shaped stop block 81 is held inside the [symbol] -shaped containing groove 611, the ball 71 is also just positioned at the second embedding slot 83 and is pressing against the second embedding slot 83, so that the jaw 6 is fixed on the slide 5.

On the other hand, to demount the jaw 6 from the limiting block 8, the user just needs to slide the [symbol] -shaped containing groove 611 of the jaw 6 from the [symbol] -shaped stop block 81 of the limiting block 8 toward the guide slot 11. When the [symbol] -shaped containing groove 611 of the jaw 6 slides to the extent that it is separated from the [symbol] -shaped stop block 81 of the limiting block 8, the ball 71 is just at the first embedding slot 82 and is separated from the second embedding slot 83. At this time, the user just needs to push the jaw 6 upward to be removed from the limiting block 8.

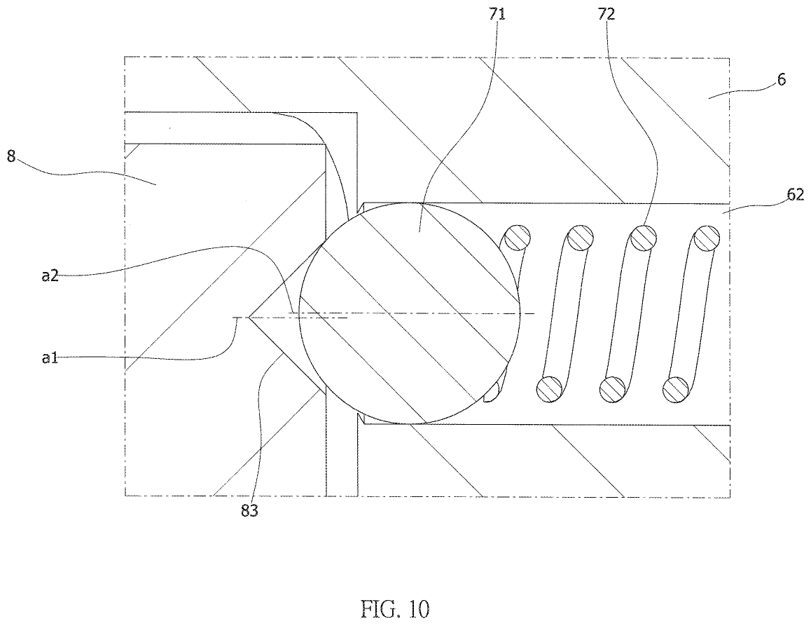

As shown in FIG. 10, the axle center a1 of the [symbol] -shaped containing groove 611 is lower than the axle center a2 of the limiting component 7. Thus, when the jaw 6 is mounted on the limiting block 8, due to the different heights of the [symbol] -shaped containing groove 611 and the limiting component 7, the limiting component 7 will press the jaw 6 downward to bind the jaw 6 and the vice main body 1 tightly together, to effectively avoid floating of the jaw 6; moreover, the height difference makes it easy to demount the jaw 6 for replacement. The user just needs to apply an upward force to easily remove the jaw 6 from the limiting block 8. The operation is very convenient.

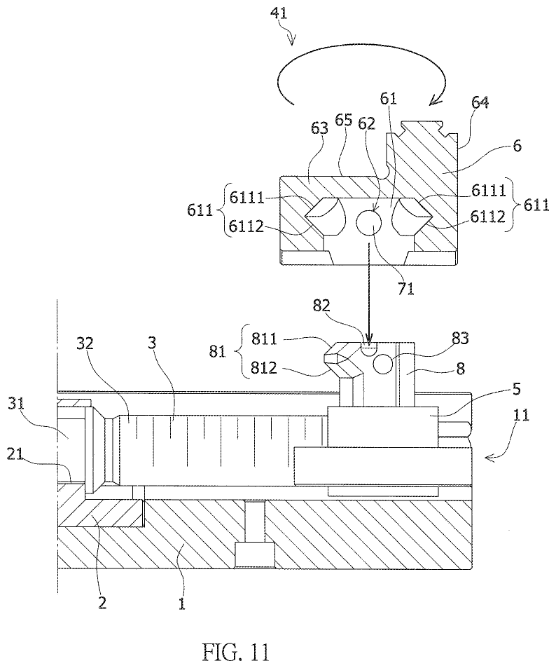

As shown in FIG. 11, the jaw 6 is an integrally formed L-shape seat, made up of a clamping seat 63 to be fitted on the slide 5 and a clamping block 64 extending and protruding upward from one side of the clamping seat 63, and a notch 65 is formed between the clamping block 64 and the clamping seat 63 to hold the work piece [not shown in the figure].

Moreover, because the size of the work piece [not shown in the figure] is not certain, through the design of the L-shaped seat of the jaw 6, the jaw 6 can be mounted to according to the size of the work piece [not shown in the figure]. A small-size work piece [not shown in the figure] can be placed on the vice main body 1 to be clamped. In the case of a big-size work piece [not shown in the figure], by deflecting of the jaw 6, the work piece [not shown in the figure] can be placed at the notch 65 to be clamped. Thus, the relative position of the jaw 6 can be quickly adjusted to match the size of the work piece [not shown in the figure] to be clamped. Therefore, the present invention is practical and can meet the needs of industrial applications.

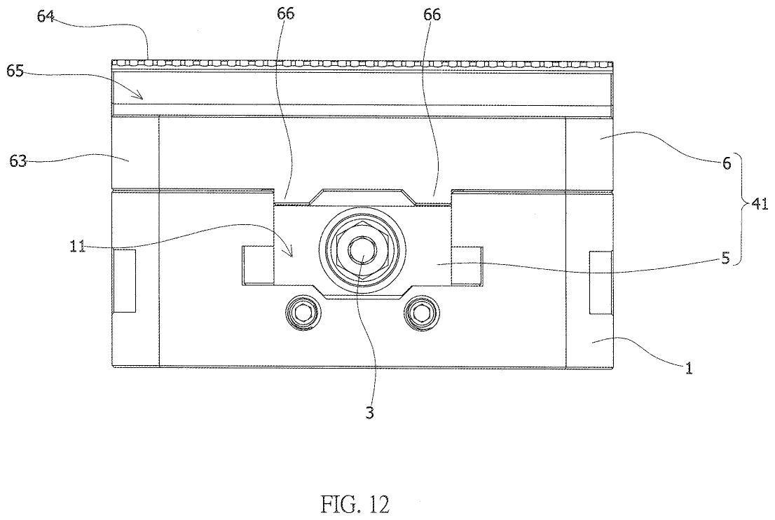

As shown in FIG. 12, the bottom of the jaw 6 protrudes toward the guide slot 11 to form two corresponding positioning convex blocks 66. The two positioning convex blocks 66 respectively contact the wall of the vice main body 1 on a vertical line, so that the jaw 6 can deflect to the left or right, to tightly press on the clamped surfaces [not shown in the figure] of the work piece [not shown in the figure], so that the work piece [not shown in the figure] can be stably clamped.

I claim:

1. A vice jaw quick demounting structure, comprising:
a vice main body (1), having a guide slot (11) that extends vertically;
a lead screw positioning seat (2), configured in the center of the guide slot (11), having a lead screw positioning groove (21); a lead screw (3), with its center configured with a positioning portion (31), the positioning portion (31) is positioned at the lead screw positioning groove (21), and the two sides of the positioning portion (31) are respectively configured with positive external spiral threads (32) and reverse external spiral threads (33); and
a clamping and fixing module (4), including a first flexible jaw set (41) and a second flexible jaw set (42) configured inside the guide slot (11) of the vice main body (I), capable of sliding, the first jaw set (41) has positive internal spiral threads (411) designed to match the positive external spiral threads (32) of the lead screw (3), the second jaw set (42) has reverse internal spiral threads (421) designed to match the reverse external threads (33) of the lead screw (3), so that the first jaw set (41) and the second jaw set (42) will generate simultaneous clamping or releasing actions when the lead screw (3) is rotated;
wherein the first jaw set (41) and second jaw set (42) both include a slide (5) that can slide inside the guide slot (11) configured on the vice main body (1), a jaw (6) to be fitted on the slide (5), and a limiting component (7) respectively configured on the left side wall and right side wall of the jaw (6);
a top wall of the slide (5) is configured with a limiting block (8) protruding toward the jaw (6), one side of the limiting block (8) is extended and protruded to form a [symbol] -shaped stop block (81), and the left side wall and the right side wall of the limiting block (8) are both configured with a first embedding slot (82) and a second embedding slot (83) in upper and lower arrangement;
a bottom of the jaw (6) is configured with a slide chamber (61) that can be fitted on the limiting block (8), for the jaw (6) to be fixed on the slide (5), the front side inner wall and rear side inner wall of the slide chamber (61) respectively have a [symbol] -shaped containing groove (611) to match the [symbol] -shaped stop block (81), and the left side wall and right side wall of the jaw (6) are respectively configured with a through hole (62) that is communicated to the slide chamber (61);
the limiting component (7) goes through the through hole (62) and can slide between the first embedding slot (82) and the second embedding slot (83), when the limiting component (7) is fitted in the second embedding slot (83), the [symbol] -shaped stop block (81) is held inside the [symbol] -shaped containing groove (611) and pressed against the front side inner wall or rear side inner wall of the [symbol] -shaped containing groove (611), so that the jaw (6) is fixed on the slide (5), when the limiting component (7) is fitted in the first embedding slot (82), the [symbol] -shaped stop block (81) is separated from the [symbol] -shaped containing groove (611), so that the jaw (6) can be demounted from the slide (5).

2. The vice jaw quick demounting structure defined in claim 1, wherein the [symbol] -shaped stop block (81) is made up of a first slope (811) extending from one side of the limiting block (8), and a second slope (812) configured in mirror symmetric relationship to the first slope 811, the [symbol] -shaped containing groove (611) is made up of a first slope inner wall surface (6111) and a second slope inner wall surface (6112) matching the first slope (811) and the second slope (812), when the jaw (6) is fitted on the slide (5), the [symbol] -shaped stop block (81) is held inside the [symbol] -shaped containing groove (611) and the second slope (812) is pressed against the second slope inner wall surface (6112) of the [symbol] -shaped containing groove (611), so that the jaw (6) is fixed on the slide (5).

3. The vice jaw quick demounting structure defined in claim 1, wherein the limiting component (7) is made up of a ball (71) held inside the through hole (62), an elastic body (72) pressed against the ball (71), and a screw locking component (73) contacting the elastic body (72) to press against the elastic body (72).

4. The vice jaw quick demounting structure defined in claim 1, wherein the jaw (6) is an integrally formed L-shaped seat, having a clamping seat (63) to be fitted on the slide (5), and a clamping block (64) extending and protruding from one side of the clamping seat (63), a notch (65) is formed between the clamping block (64) and the clamping seat (63) to hold the work piece.

5. The vice jaw quick demounting structure defined in claim 1, wherein the bottom of the jaw (6) protrudes toward the guide slot (11) to form two corresponding positioning convex blocks (66), the two positioning convex blocks (66) respectively contact the wall of the vice main body (1) on a vertical line, so that the jaw (6) can deflect to the left or right, to tightly press on the clamped surfaces of the work piece, so that the work piece can be stably clamped.

6. The vice jaw quick demounting structure defined in claim 1, wherein the axle center (a1) of the [symbol] -shaped containing groove (611) is lower than the axle center (a2) of the limiting component (7).
